(19) United States
(12) Patent Application Publication
(10) Pub. No.: US 2004/0161241 A1
(43) Pub. Date: Aug. 19, 2004

(54) Apparatus for compensating for dispersion and wavelength division multiplexing communications system using the apparatus

(76) Inventors: Hiroaki Tomofuji, Kawasaki (JP); Takuji Maeda, Kawasaki (JP); Yuji Shimada, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/759,838

(22) Filed: Jan. 16, 2004

(30) Foreign Application Priority Data
Feb. 19, 2003 (JP) 2003-041393

(51) Int. Cl. H04B 10/12

(52) U.S. Cl. 398/147

(57) ABSTRACT

An apparatus for compensating for dispersion include a wavelength-selective optical switching unit which receives at one input thereof a WDM signal into which a plurality of wavelengths are multiplexed, and demultiplexes the WDM signal so as to output the demultiplexed wavelengths at desired output ports while switching routes of the demultiplexed wavelengths leading to the output ports; a plurality of dispersion compensation units which are connected to the respective output ports, and have respective, different dispersion values; and a multiplexing unit which receives at a plurality of input ports thereof the demultiplexed wavelengths output from the dispersion compensation units, and multiplex the demultiplexed wavelengths to generate a WDM signal.

### BACKGROUND OF THE INVENTION

1. Field of the Invention

The present invention generally relates to an apparatus for compensating for dispersion and a wavelength division multiplexing communications system using the apparatus, and particularly relates to the apparatus for compensating for dispersion and the wavelength division multiplexing communications system using the apparatus used in an optical transmission system.

2. Description of the Related Art

In recent years, with a rapid popularization of the Internet and also with a development of the multimedia society, a demand for communications has been growing rapidly in each country and, in order to respond to the growing demand, an introduction of trunk optical transmission systems using a WDM (Wavelength Division Multiplexing) technology is currently in progress, and an expansion in the transmission capacity is being sought.

FIG. 1 is a block diagram illustrating one example of the related-art WDM communications system. Referring to FIG. 1, each of a plurality of the optical transmitters 10 transmits an optical signal of a different wavelength. These optical signals, after being adjusted by a plurality of the optical attenuators 11 to keep the optical power constant, are optically multiplexed by the optical multiplexer 12. The WDM signals which the optical multiplexer 12 outputs are all together amplified by the optical post amplifier 13 and sent out to the optical transmission line 14, and amplified by the optical inline amplifier 15 along the optical transmission line 14 and transmitted to the optical add-drop multiplexer (OADM) 16.

In the optical add-drop multiplexer 16, a drop/add of the optical signal is performed and, the WDM signal which the optical add-drop multiplexer 16 outputs is transmitted through the optical transmission line 17, supplied via the optical preamplifier 18 to the optical demultiplexer 19 wherein demultiplexing per wavelength is performed, and then received by a plurality of optical receivers 20.

In a terrestrial WDM communications system with a transmission rate of 10 Gigabits/sec, a system using 40-wavelength multiplexing with wavelength spacing of 100 GHz (approximately 0.8 nm) and 88-wavelength multiplexing with wavelength spacing of 50 GHz (approximately 0.4 nm) which enables to transmit up to 150 kilometers is being developed. Herein, the wavelength band of about 32 nm through 36 nm is used.

In case of transmitting long distance with a WDM communications system, dispersion compensation is one of the issues. In a long range transmission system, as an Erbium Doped Fiber Amplifier (hereinafter abbreviated as EDFA) is used for the optical amplifiers, the transmission is performed in the 1.5 micrometer band to be in line with the band of amplification.

As an optical transmission line for a WDM transmission, a zero-dispersion Single Mode Fiber (hereinafter abbreviated as SMF) in the 1.3 micrometer band with a large dispersion of about +18 ps/nm/km in the 1.55 micrometer band, and a Non Zero—Dispersion Shifted Fiber (hereinafter abbreviated as NZ-DSF) with a small dispersion in the 1.55 micrometer band are used.

In this way, the reason an optical transmission line has dispersion of about a few ps/nm/km is that, when a wavelength division multiplexed signal is transmitted near the zero-dispersion wavelength, a coherent light is produced by the four-wave mixing phenomenon, which is to be avoided.

Wavelength dispersion is a phenomenon in which the propagation speed of a lightwave pulse depends upon the wavelength (frequency) of the light. The lightwave pulse modulated into high-speed will have a wide spectrum in the frequency domain, and, as such lightwave pulse propagates through an optical fiber, the propagation speeds of a short wavelength component and of a long wavelength component differ due to the effect of wavelength dispersion, and the waveform of the lightwave pulse changes. In order to alleviate such effect of wavelength dispersion, compensating for the dispersion value of a lightwave pulse by using a dispersion compensation module (dcm) with the dispersion value inverse to the dispersion value of the optical fiber, has been performed up to now.

As the dispersion compensation module,

(1) A composition using a grating;

(2) A composition using an optical interferometer; and

(3) A composition using an optical fiber, etc. are being proposed.

Of the proposals, a dispersion compensation module using an optical fiber is being widely used, as the dispersion compensation module does not need any controlling circuit etc. so that passive operations are enabled, and the wavelength band used is quite wide as compared with the dispersion compensation modules in the other compositions (Refer to, for example, the Patent Documents 1, 2 and 3.).

In a terrestrial WDM system which performs transmission at a transmission rate of a few tens of Gigabits per second, a dispersion compensation module is inserted into the middle stage of an optical amplifier and WDM signals are all together compensated for. As the dispersion of an optical fiber has dependency on the wavelength, the dispersion coefficients slightly differ per wavelength as illustrated in FIG. 2. This is called the secondary dispersion, or the dispersion slope. Illustrated in FIG. 2 are the dispersion slopes for SMF, NZ-DSF, and DCM, the dispersion slope for SMF compensated by DCM and the dispersion slope for NZ-DSF compensated by DCM.

Also in case of performing a long distance transmission, the deviations in the amount of dispersion among each of the wavelengths become so large due to the dispersed slope as to exceed the acceptable dispersion value for a receiver. In order to compensate for this, an inverse dispersion slope is provided to the dispersion compensation module.

The Patent Document 1

JP9-218314A

The Patent Document 2

JP9-261173A

The Patent Document 3

JP11-204866A

In order to make the amount of dispersion among each wavelength after dispersion compensation zero, assuming the primary dispersion coefficient for SMF as D1(ps/nm/km), the secondary dispersion coefficient for SMF as S1(ps/nm squared/km), the primary dispersion coefficient for DCM as D2, and the secondary dispersion coefficient for DCM as S2, it is indispensable that S1/D1 equals S2/D2.

With NZ-DSF it was indispensable to have as compared with SMF a large value for S2/D2, or a large dispersion slope, and the single dispersion compensation module of the related art was insufficient to compensate for so that it was necessary to limit the transmission distance in order to perform the sufficient dispersion compensation. Also for a long range transmission, there were many instances in which a node to add/drop a signal (an OADM) is inserted along the line of transmission, and, in this connection, routes that each signal pass through differ so that there existed a problem of not being able to carry out the optimal dispersion compensation for each of the wavelengths.

On the other hand, in case of transmission at the transmission rate of 40 Gigabits/sec, the acceptable deviation of dispersion compensation is narrow at −25 ps/nm to 25 ps/nm. Therefore, it is necessary to compensate with high precision for the wavelength dependency of the dispersion of the optical transmission line. For example, in case of SMF as the transmission line, assuming the dispersion slope of 0.08 (ps/nm squared/km), the wavelength band of 32 nm, the transmission distance of 600 km, and the slope compensation of 5%, 0.08×32×600×0.05=80(ps/nm), which exceeds the acceptable deviation of the dispersion compensation. Furthermore, there existed a problem of not being able to ignore the higher order dispersion of secondary or higher.

### SUMMARY OF THE INVENTION

It is a general object of the present invention to provide an apparatus for compensating for dispersion and also a wavelength division multiplexing communications system using the apparatus that substantially obviate one or more problems caused by the limitations and disadvantages of the related art.

In view of the above points, it is a more particular object of the present invention to provide an apparatus for compensating for dispersion which enable to set an optimum dispersion value per wavelength and to compensate with high precision for the wavelength dependency of a dispersion of an optical transmission line and a wavelength division multiplexing communications system using the apparatus.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by the apparatus for compensating for dispersion and the wavelength division multiplexing communications system using the apparatus particularly pointed out in the specification in such full, clear, concise, and exact terms as to enable a person having ordinary skill in the art to practice the invention.

According to the invention, an apparatus for compensating for dispersion includes a wavelength-selective optical switching unit which receives at one input port thereof a WDM signal into which a plurality of wavelengths are multiplexed, and demultiplexes the WDM signal so as to output the demultiplexed wavelengths at desired output ports while switching routes of the demultiplexed wavelengths leading to the output ports, a plurality of dispersion compensation units which are connected to the respective output ports, and have respective, different dispersion values, and a multiplexing unit which receives at a plurality of input ports thereof the demultiplexed wavelengths output from said dispersion compensation units, and multiplex the demultiplexed wavelengths to generate a WDM signal.

The apparatus for compensating for dispersion as described above enables to set an optimum dispersion value per wavelength and to compensate with high precision for the wavelength dependency of dispersion of an optical transmission line.

According to another aspect of the invention, a wavelength-selective optical switching unit further includes a specific output node that is not connected to the dispersion compensation units, and outputs a specific demultiplexed wavelength from the specific output port.

The wavelength-selective optical switching unit as described above enables to adjust the dispersion compensation values for each wavelength and to drop a specific wavelength at the same time.

According to another aspect of the invention, a multiplexing unit receives a specific wavelength from a specific input port among the plurality of input ports and multiplexes a plurality of demultiplexed wavelengths output by said plurality of dispersion compensation units and said specific demultiplexed wavelength.

The multiplexing unit as described above enables to adjust the dispersion compensation values of the respective wavelengths and to add a specific wavelength at the same time.

According to another aspect of the invention, an apparatus for compensating for dispersion includes an optical circulating unit which includes a first port, a second port and a third port, and which receives at the first port a first WDM signal into which a plurality of wavelengths is multiplexed so as to output from the second port the first WDM signal, and receives a second WDM signal at the second port so as to output from the third port the second WDM signal, a wavelength-selective optical switching unit which receives from said second port and at one input port a WDM signal into which said plurality of wavelengths are multiplexed and demultiplexes the WDM signal so as to output the demultiplexed wavelengths at desired output ports while switching routes of the demultiplexed wavelengths leading to the output ports, a plurality of dispersion compensation units which are connected to the respective output ports of said wavelength-selective optical switching unit, and have respective, different dispersion compensation values, and a plurality of reflecting units which reflect and return output light at end section of said respective dispersion compensation units.

The apparatus for compensating for dispersion as described above enables to use a single unit of wavelength-selective optical switching also as a multiplexing unit, thus simplifying the composition.

Other objects and further features of the present invention will be apparent from the following detailed description when read in conjunction with the accompanying drawings.

### BRIEF DESCRIPTION OF THE DRAWINGS

FIG. 1 is a block diagram of an example of the related-art WDM communications system;

FIG. 2 is a diagram which illustrates the dispersion slopes of SMF, NZ-DSF and DCM, the dispersion slope in which SMF is compensated for by a dispersion compensation module, and the dispersion slope in which the NZ-DSF is compensated for by a dispersion compensation module;

FIG. 3 is a block diagram of a first embodiment according to the invention;

FIG. 4A is a diagram which illustrates the remaining amount of dispersion compensation for an input optical signal and the dispersion compensation value for a dispersion compensating module;

FIG. 4B is a diagram which illustrates the dispersion compensation value for a dispersion compensating module;

FIG. 4C is a diagram which illustrates the remaining amount of dispersion compensation for an output optical signal;

FIG. 5 is a block diagram of a second embodiment according to the invention;

FIG. 6 is a block diagram of a third embodiment according to the invention;

FIG. 7 is a block diagram of a first embodiment of a WDM communications system using an apparatus for compensating for dispersion according to the invention;

FIG. 8 is a block diagram of a fourth embodiment according to the invention;

FIG. 9 is a block diagram of a second embodiment of a WDM communications system using an apparatus for compensating for dispersion according to the invention;

FIG. 10 is a block diagram of a third embodiment of a WDM communications system using an apparatus for compensating for dispersion according to the invention; and

FIG. 11 is a diagram which illustrates the dispersion compensation amount for a dispersion compensation module.

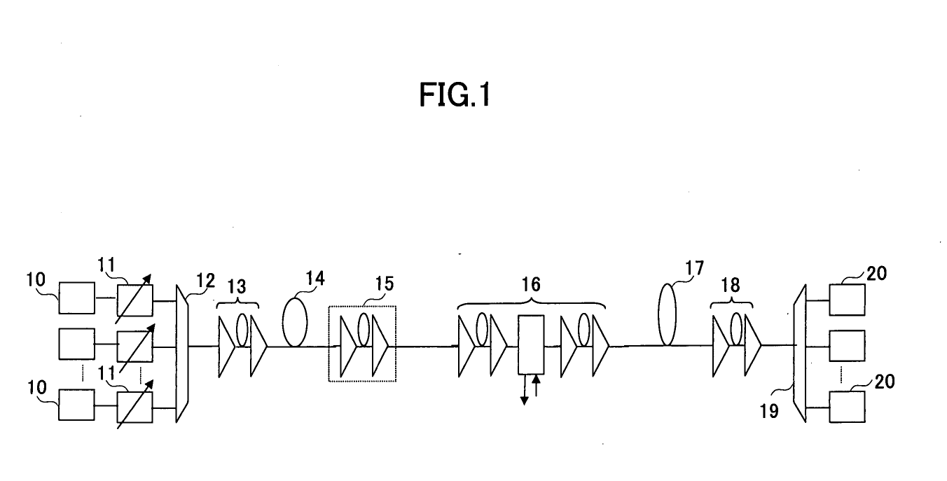

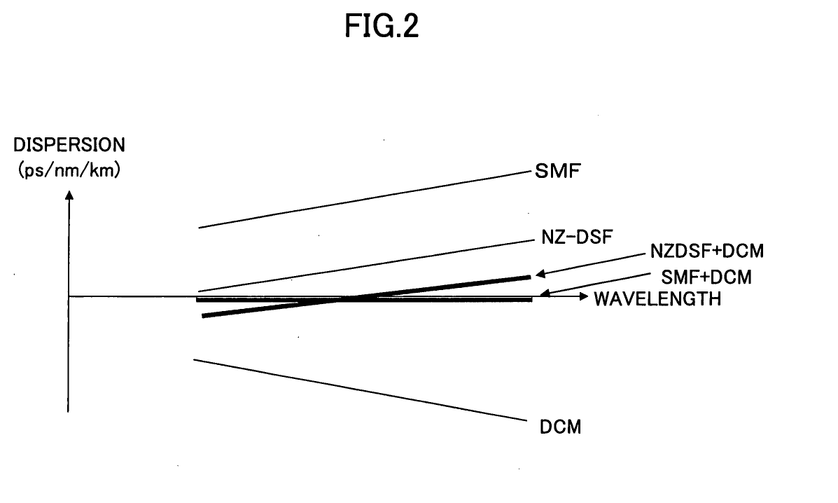

### DETAILED DESCRIPTION OF THE PREFERRED EMBODIMENTS

In the following, embodiments of the present invention will be described with reference to the accompanying drawings.

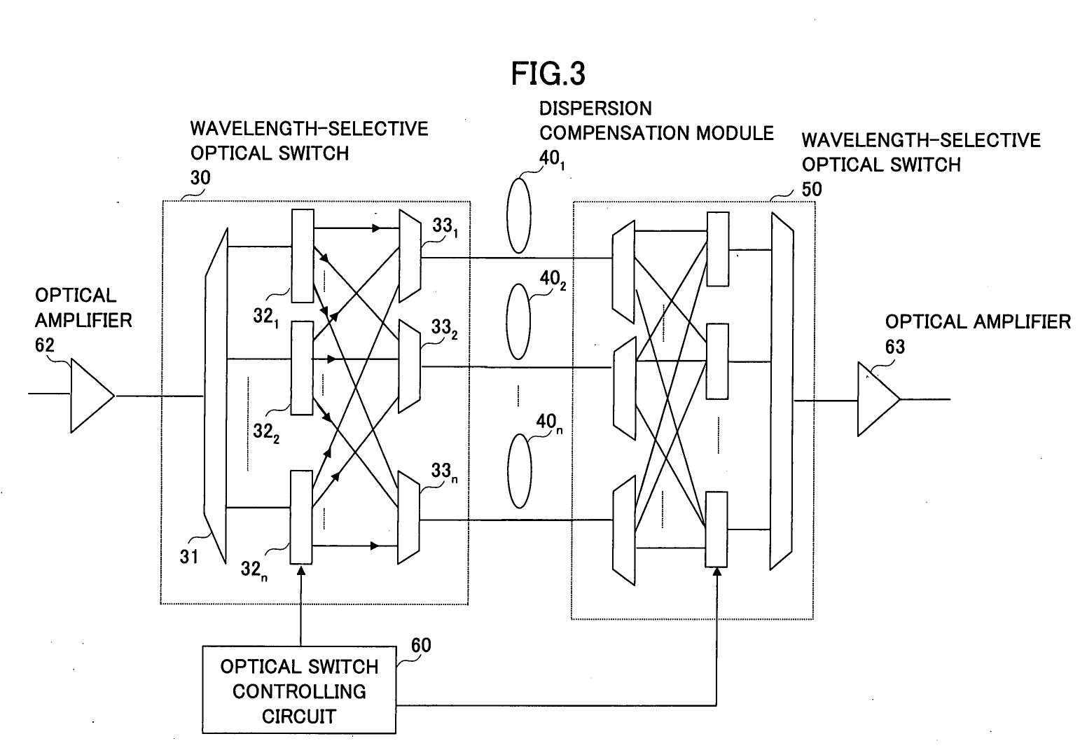

FIG. 3 is a block diagram illustrating a first embodiment of the apparatus for compensating for dispersion according to the invention. In FIG. 3, the apparatus for compensating for dispersion is composed of the wavelength-selective optical switches 30 and 50, and the dispersion compensation modules 40-1 through 40-n, and the optical switch controlling circuit 60.

The wavelength-selective optical switch 30 has n output ports per one input port and receives a WDM signal from the optical amplifier 62. The wavelength-selective optical switch 30 demultiplexes the WDM signal and switches routes of the demultiplexed wavelength signals to desired output ports in response to the control of the optical switching controlling circuit 60.

The n dispersion compensation modules 40-1 through 40-n, connected to the respective output ports of the wavelength-selective optical switch 30, have different dispersion compensation values, and the demultiplexed wavelength signals output from each of the dispersion compensation modules 40-1 through 40-n are connected to the n input ports of the wavelength-selective optical switch 50. The wavelength-selective optical switch 50 has one output port per n input ports, and enables to multiplex into one WDM signal by appropriately controlling the signals, with different wavelengths received from each input port. The WDM signal multiplexed by the wavelength-selective optical switch 50 is output from the output port through the optical amplifier 63.

As the above-mentioned wavelength-selective optical switch 30, a composition of, diffraction device 31, small-sized mirrors (MEMS-SW) 32-1 through 32-n which enable to receive, and to switch routes for the outputs, the respective wavelengths demultiplexed by the diffraction device 31, and diffraction devices 33-1 through 33-n which multiplex lights from the respective small-sized mirrors (MEMS-SW) 32-1 through 32-n in order to lead to a plurality of routes, may be contemplated. As for an example of n=4, a description is in the Document: D. M. Marcom et. al, “Wavelength-selective 1×4 switch for 128 WDM channels at 50 GHz spacing” OFC2002 PD-FB7. Also, a Wavelength-selective optical switch 50 can be implemented by using a Wavelength-selective optical switch 30 with the input and the output of the switch reversed.

For the dispersion compensation modules 40-1 through 40-n, a dispersion compensated fiber is used, for example. Assuming the deviation amount of dispersion among the wavelengths to be compensated for as D (ps/nm), and a number of output ports of the wavelength-selective optical switch 30 as n, the amount of dispersion of each dispersion compensated fiber, is provided as −D/n, 2D/n, through, −D (ps/nm) and the dispersion compensation values of each dispersion compensated fiber are set at regular intervals. A particular one among the dispersion compensation modules 40-1 through 40-n for a particular demultiplexed wavelength to pass through is determined so as to keep the deviation amount of dispersion small for the particular demultiplexed wavelength and the wavelength-selective optical switch 30 is controlled by the optical switch controlling circuit 60 so as to output the demultiplexed wavelengths to the routes leading to the dispersion compensation modules. Besides, the optical switch controlling circuit 60 receives, from an apparatus of a higher order not illustrated, the controlling information on to what extent the dispersion compensation is to be performed for each of the wavelengths within the WDM signal in response to the wavelength and route (transmission distance).

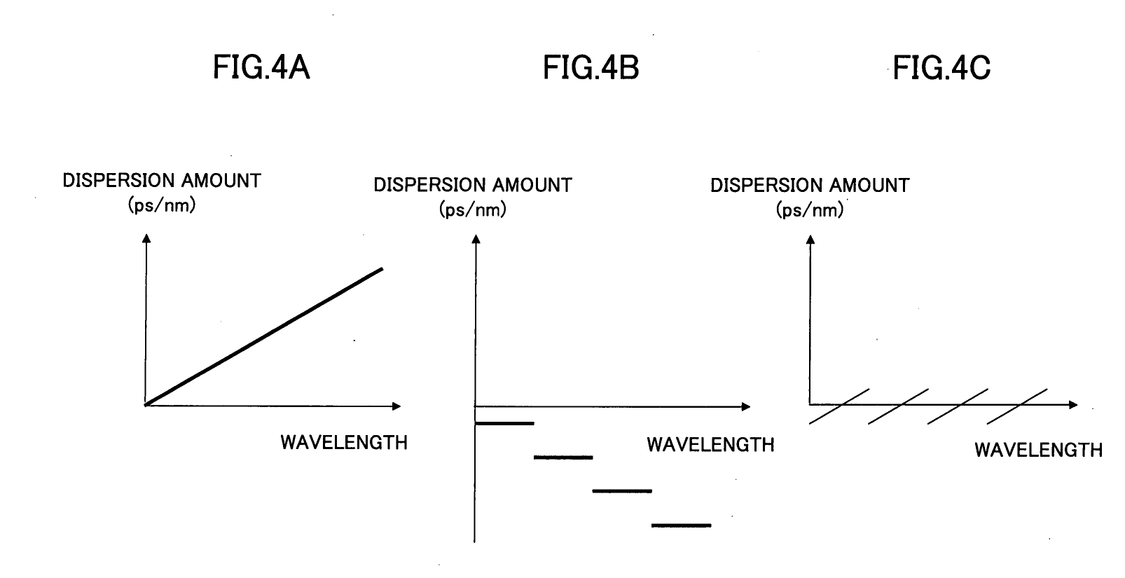

Hereby, the dispersion compensation deviation among the wavelengths after passing through the dispersion compensation modules is compressed down to D/n. In case the remaining amount of dispersion compensation of the input optical signal is as illustrated in FIG. 4A, if the dispersion compensation value of the dispersion compensation modules 40-1 through 40-4 is set as illustrated in FIG. 4B, the remaining amount of dispersion compensation of the optical signal output by the wavelength-selective optical switch 50 will be as illustrated in 4C.

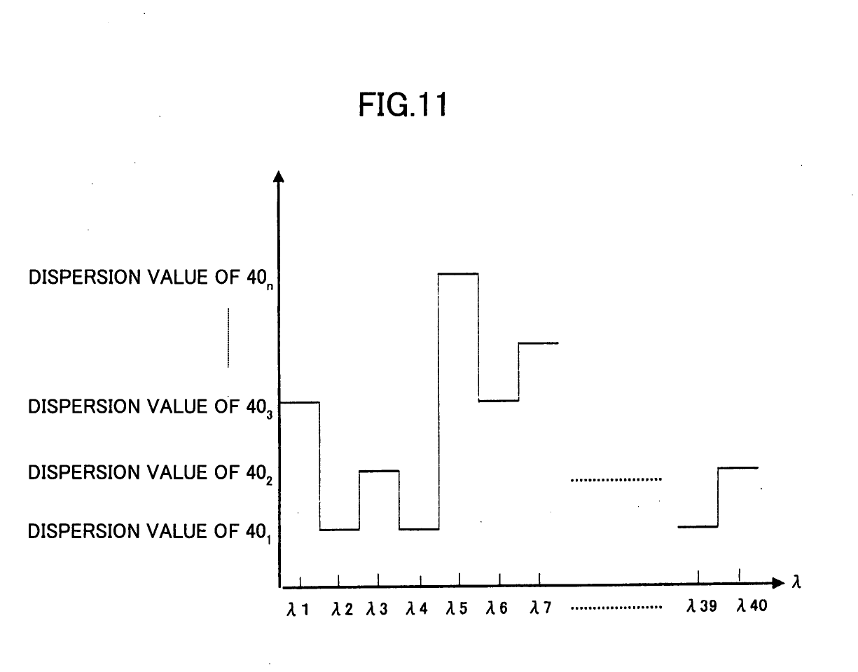

Here, although a case in which the remaining amount of dispersion compensation is linear in relation to the wavelength is illustrated, as aftermentioned, in an OADM system and a ring network in which the demultiplexed wavelengths are added/dropped at desired locations along a transmission line, an optimal amount of dispersion compensation differs per wavelength, and as illustrated in FIG. 11, there may be a case in which an optimal dispersion compensation amount per wavelength is selected.

Moreover, the dispersion compensation value of compensator 40-1 through 40-n may be set not at regular intervals, but at uneven intervals. Also, in the wavelength-selective optical switch 30, it may be that the WDM signal is demultiplexed per wavelength for which the route is selected, but it may also be that the WDM signal is demultiplexed to a plurality of wavelength groups and the route is selected per wavelength group.

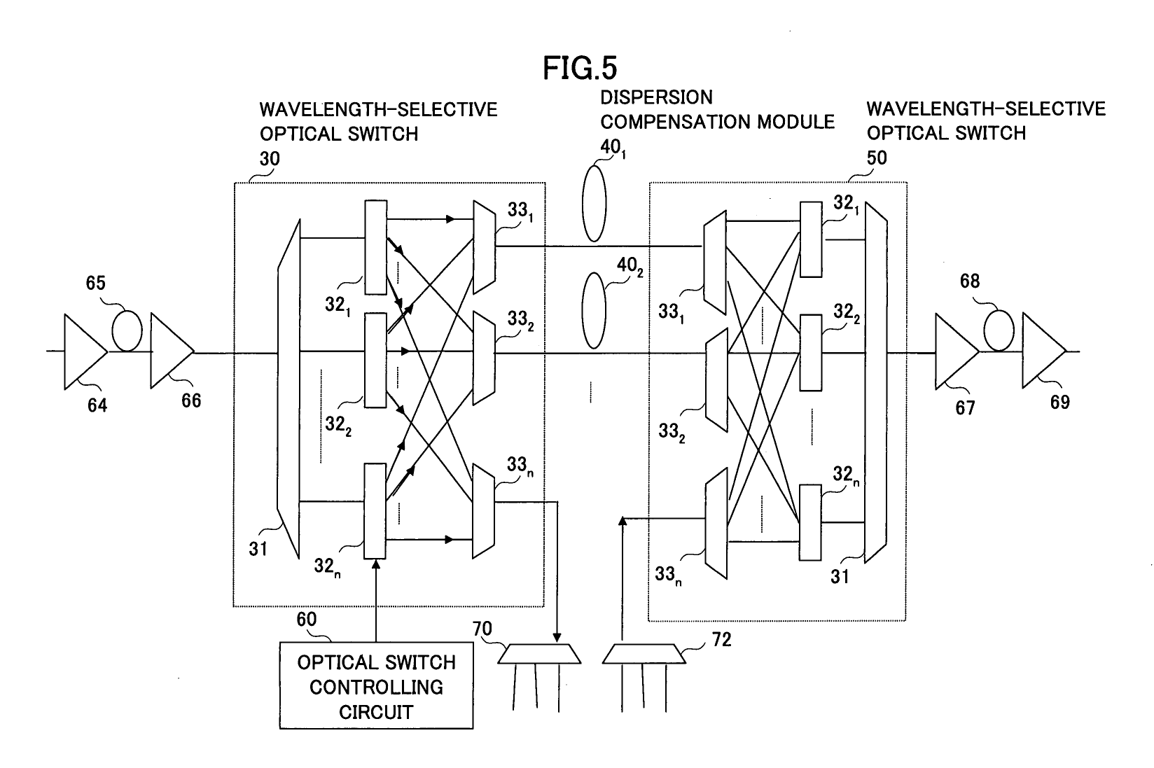

FIG. 5 illustrates a block diagram for a second embodiment of an apparatus for compensating for dispersion according to the invention. In FIG. 5, the same reference letters are attached to the parts which are the same as in FIG. 3.

In FIG. 5, the wavelength-selective optical switch 30 has n output ports per one input port, and receives a WDM signal via the optical amplifier 64, the dispersion compensation module 65 and the optical amplifier 66. The wavelength-selective optical switch 30 demultiplexes the WDM signal, and switches the demultiplexed wavelength signals to desired output ports in response to the control of the optical switch controlling circuit 60. Besides, the optical switch controlling circuit 60 receives from an apparatus of a higher order not shown, the controlling information on to what extent the dispersion compensation is performed in response to the wavelength and route (transmission distance).

Of the diffraction Devices 33-1 through 33-n which compose the wavelength-selective optical switch 30, the diffraction device 33-n is used for the drop of an optical signal, and the optical signal output from the output port of diffraction device 33-n is demultiplexed per wavelength and output at the optical demultiplexer 70.

Of the diffraction devices 33-1 through 33-n of the wavelength-selective optical switch 30, each output port except for the diffraction device 33-n is connected to n-1 dispersion compensation modules 40-1, The respective dispersion compensation modules 40-1, have different dispersion compensation values, and the demultiplexed wavelength signals output from each of the dispersion compensation modules 40-1, are connected to n-1 input ports of the wavelength-selective optical switch 50. The wavelength-selective optical switch 50 has one output port per n input ports, and the input port of the diffraction device 33-n out of the diffraction devices 33-1 through 33-n which compose the wavelength-selective optical switch 50, is connected to the optical multiplexer 72 so as to be used for the add of the optical signals. The optical signal multiplexed in the optical multiplexer 72 is input into the diffraction device 33-n of the wavelength-selective optical switch 50, and is multiplexed with the optical signals received through each of the dispersion compensation modules 40-1 . . . .

In this way, it is possible to carry out adjustment of the dispersion compensation value of each wavelength while having a function as an optical add/drop apparatus at the same time.

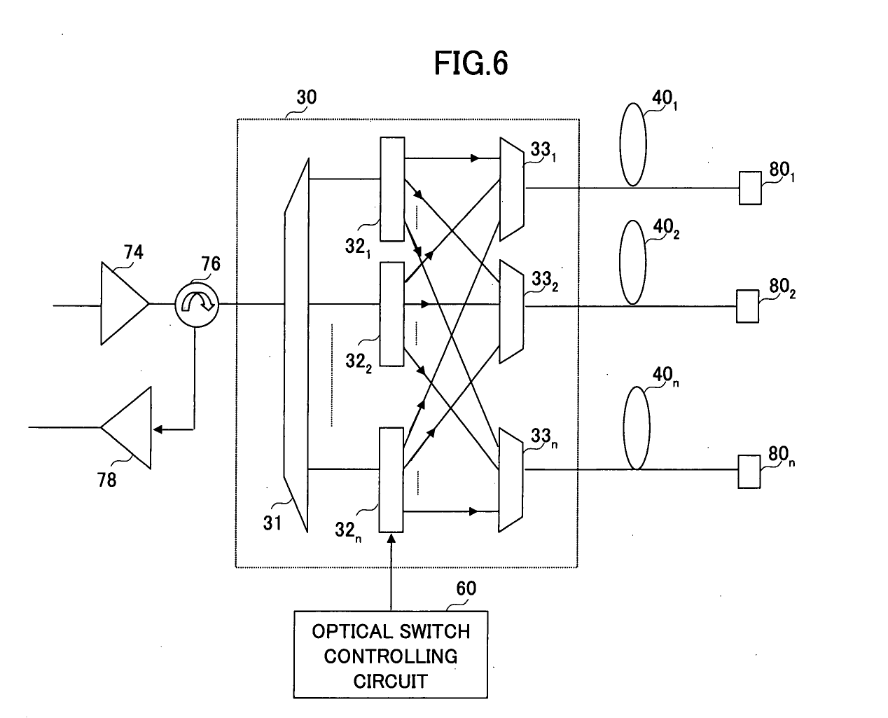

FIG. 6 illustrates a block diagram of a third embodiment of the apparatus for compensating for dispersion according to the invention. In FIG. 6, the same reference letters are attached to the parts which are the same as in FIG. 3.

In FIG. 6, a WDM signal input from the optical amplifier 74 into a first port of the optical circulator 76 is supplied to an input port of the wavelength-selective optical switch 30 from a second port of the optical circulator 76. The wavelength-selective optical switch 30 has n output ports per one input port and is supplied the WDM signal from the input port. The wavelength-selective optical switch 30 demultiplexes the WDM signal and switches the demultiplexed wavelength signals to desired output ports in response to the control by the optical switch controlling circuit 60. Besides, the optical switch controlling circuit 60 receives from an apparatus of a higher order which is not illustrated, the controlling information on to what extent the dispersion compensation is performed for each of the wavelengths within the WDM signal in response to the wavelength and route (transmission distance).

The respective N dispersion compensation modules 40-1 through 40-n connected to each of the output ports of the wavelength-selective optical switch 30 have different dispersion compensation values. At the end section of the respective dispersion compensation modules 40-1 through 40-n, the optical reflectors 80-1 through 80-n are provided. The optical reflectors 80-1 through 80-n are composed by, for example, vacuum evaporation of a mirror to each of the end faces of a dispersion compensated fiber as the dispersion compensation modules 40-1 through 40-n.

The demultiplexed optical signal of each wavelength output by the wavelength-selective optical switch 30, after dispersion compensated at the respective dispersion compensation modules 40-1 through 40-n, is reflected and returned at the respective optical reflectors 80-1 through 80-n, dispersion compensated again at the respective dispersion compensators 40-1 through 40-n, received at each of the output ports of the wavelength-selective optical switch 30, and then travels in the reverse direction within the wavelength-selective optical switch 30, and is multiplexed into the WDM signal and output from the input port of the wavelength-selective optical switch 30. The WDM signal is received at the second port of the optical circulator 76, output from a third port of the optical circulator 76 and supplied to the optical amplifier 78, and amplified and output by the optical amplifier 78.

In this embodiment, a single wavelength-selective optical switch 30 enables to function also as the wavelength-selective optical switch 50 so as to keep the composition simple. Also, the dispersion compensation value of each of the dispersion compensators 40-1 through 40-n can be set equal to half of the dispersion compensation value of the first embodiment.

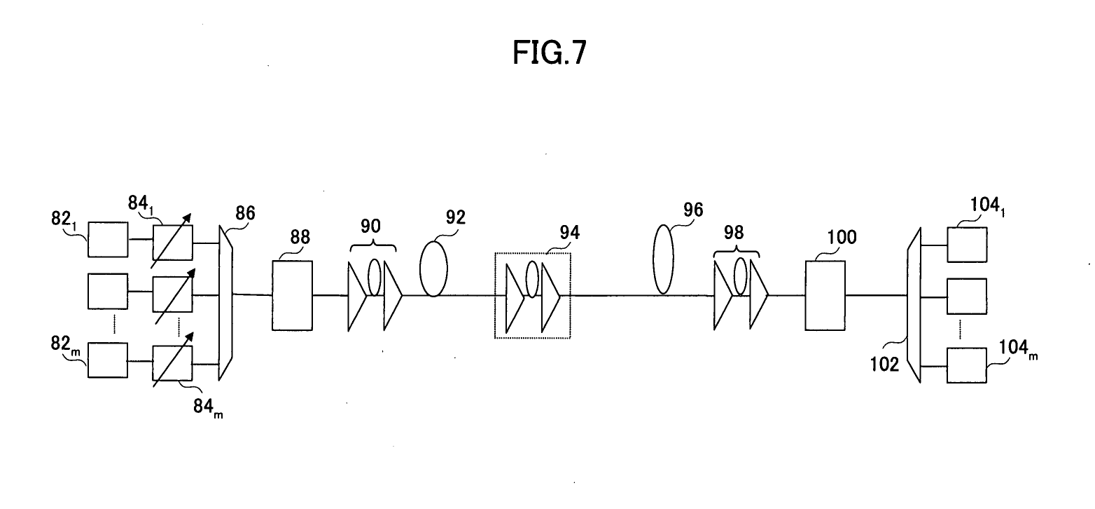

FIG. 7 illustrates a block diagram for a first embodiment of the WDM communications system using an apparatus for compensating for dispersion according to the invention. In FIG. 7, each of a plurality of the optical transmitters 82-1 through 82-m transmits an optical signal of a different wavelength. The optical signals, after having been adjusted to make the optical power constant, are optically multiplexed by the optical multiplexer 86. The WDM signal output by the optical multiplexer 86, after having been dispersion compensated at the dispersion compensation apparatus 88 according to the invention as illustrated in FIG. 3, is amplified by the optical post-amplifier 90 and sent out to the optical transmission line 92. Hereafter, the WDM signal is amplified by the optical inline amplifier 94 and transmitted through the optical transmission line 96, via the optical preamplifier 98 transmitted to the dispersion compensation apparatus 100 according to the invention in the composition as illustrated in FIG. 3, and, after dispersion compensation is performed in the apparatus, demultiplexed per wavelength by the optical demultiplexer 102, and received by a plurality of the optical receivers 104-1 through 104-M. The dispersion interval is changed between the dispersion compensation apparatus 88 at the former stage and the dispersion compensation apparatus 100 at the latter stage. For example, the dispersion compensators 40-1 through 40-N in the dispersion compensation apparatus 88 at the former stage is composed of p (n=p) dispersion compensated fibers in which the dispersion value interval is X (ps/nm), while the dispersion compensators 40-1 through 40-N in the dispersion compensation apparatus 100 at the latter stage is composed of q (n=q) dispersion compensated fibers in which the dispersion value interval is X/q (ps/nm).

Such composition, in which the dispersion compensation apparatus 88 at the former stage compensates for the WDM signal which is input with the range of pX (ps/nm), at a precision of the amount of the dispersion deviation of X, and the dispersion compensation apparatus 100 at the latter stage compensates for the output of the apparatus at a precision of the amount of dispersion deviation of X/q, enables to compensate for the amount of dispersion deviation among the wavelengths of the WDM signal input with the range of pX (ps/nm) with a precision of X/q, and is preferred in case it is necessary to adjust with high precision the dispersion compensation value among the wavelengths. Besides, the dispersion compensation apparatuses 88 and 100 may not necessarily be arranged in an non-contiguous manner, but may also be arranged in a contiguous manner.

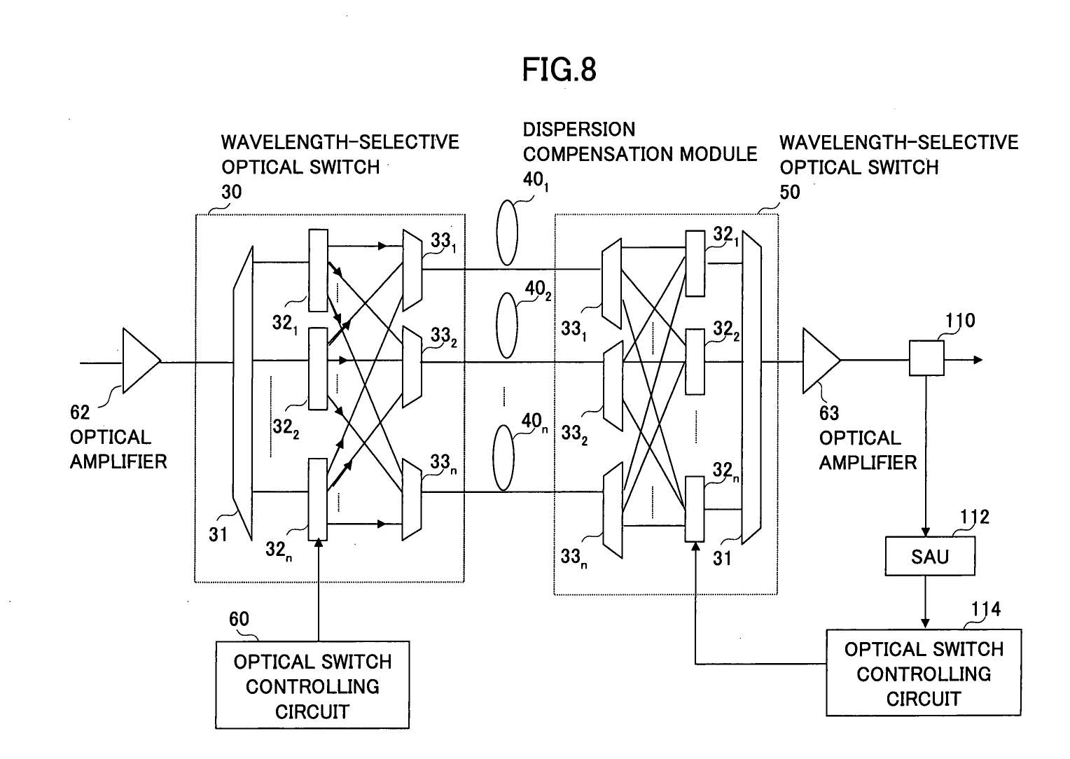

FIG. 8 illustrates a block diagram of a fourth embodiment of the dispersion according to the current invention. In FIG. 8, the same reference letters are attached to the parts which are the same as in FIG. 3, and the descriptions of the parts are omitted. In FIG. 8, some of the WDM signals output from the optical amplifier 63 are dropped at the optical drop 110 and supplied to the spectrum analyzer unit (sau) 112. The spectrum analyzer unit 112 performs detection of wavelengths of a WDM signal, monitors the power of each wavelength, and supplies to the optical switch controlling circuit 114.

The optical switch controlling circuit 114 performs adjustment of the angles of each of the small-sized mirrors 32-1 through 32-n in the wavelength-selective optical switch 50 so as to keep the power of each of the wavelengths of the WDM signal the same. By performing the adjustment of the angles of the small-sized mirrors 32-1 through 32-n, the optical loss, to the diffraction device 33-1 through 33-n, of the respective wavelengths output from the diffraction device 31, is variably adjusted so that the power levels of the respective wavelengths of the WDM signal output from the optical amplifier 63 can be adjusted to make said levels equal.

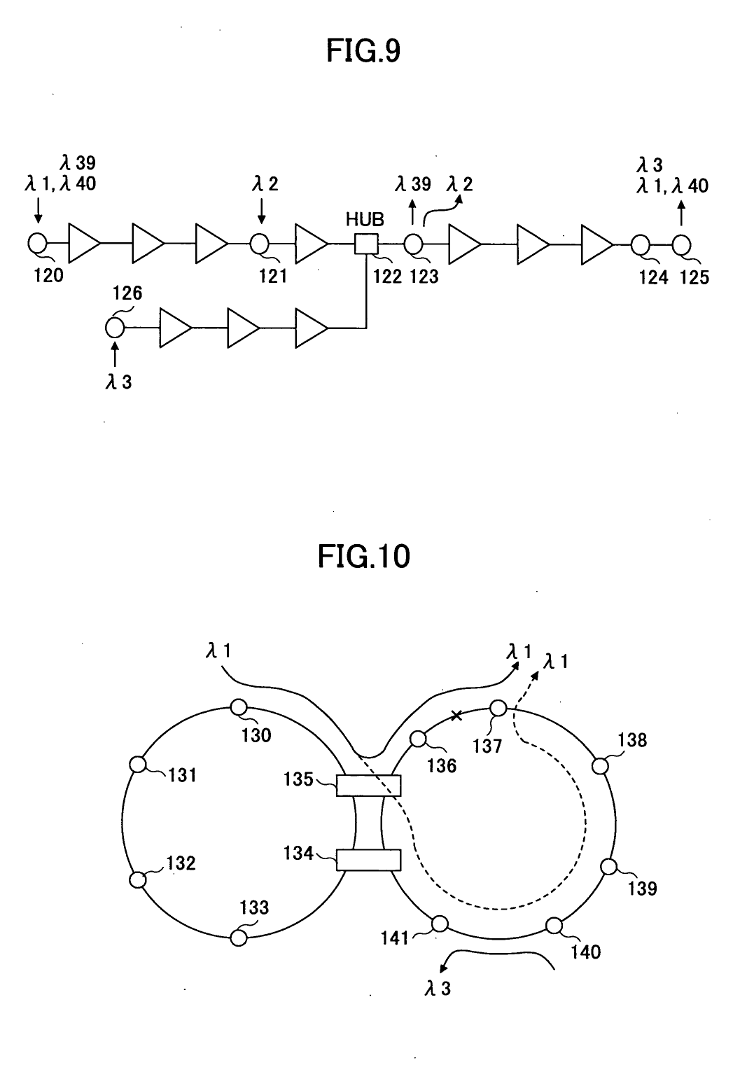

FIG. 9 illustrates a block diagram of a second embodiment of a WDM communications system using an apparatus for compensating for dispersion according to the invention. In the FIG. 9, the nodes 120 and 121 are connected to the concentrating apparatus (hub) 122 at the optical transmission line and, in a similar manner, the nodes 123, 124 and 125 are connected to the concentrating apparatus 122 at the optical transmission line, and also the Node 126 is connected to the concentrating apparatus 122 at the optical transmission line.

Hereupon, the wavelengths λ1 and λ40 which are added at the node 120 are dropped at the node 125 whereas the wavelength λ39 is dropped at the node 123, so the transmission path lengths are different. In such a system, a provision of the concentrating apparatus 122 of an apparatus for compensating for dispersion according to the invention enables an optimal dispersion compensation for the respective wavelengths having different transmission path lengths.

FIG. 10 illustrates a block diagram of a third embodiment of a WDM communications system using an apparatus for compensating for dispersion according to the invention. In FIG. 10, the nodes 130 through 135 compose a first ring network and also the nodes 134 through 141 compose a second ring network, and the nodes 134 and 135 compose both of the ring networks.

Hereupon, assume that the wavelength λ1 added at the node 130 is dropped at the node 137 via the nodes 135 and 136. In this connection, in case a failure occurs in the transmission line between the nodes 136 and 137, the route is switched so as to allow for the wavelength λ1 added at the node 130 to be dropped when reaching the node 137 via the route of nodes 136,134,141,140,139 and 138 from the node 135.

Hereby, although the transmission path lengths of the wavelength λ1 become different due to a failure occurring, in such a system, the provision of the apparatus for compensating for dispersion according to the invention at either of the nodes 134 and 135, even in case the transmission path of the wavelength λ1 is switched, enables to make the dispersion compensation value for the wavelength λ1 an optimal value in accordance with the transmission path length at the time the transmission path is switched.

Further, the present invention is not limited to these embodiments, but various variations and modifications may be made without departing from the scope of the present invention.

The present application is based on Japanese priority application No.2003-41393 filed Feb. 19, 2003, with the Japanese Patent Office, the entire contents of which are hereby incorporated by reference.

What is claimed is:

1. An apparatus for compensating for dispersion, comprising:
a wavelength-selective optical switching unit which receives at one input port thereof a signal into which a plurality of wavelengths are multiplexed, and demultiplexes the signal so as to output the demultiplexed wavelengths at desired output ports while switching routes of the demultiplexed wavelengths leading to the output ports;
a plurality of dispersion compensation units which are connected to the respective output ports, and have respective, different dispersion values; and
a multiplexing unit which receives at a plurality of input ports thereof the demultiplexed wavelengths output from said dispersion compensation units, and multiplexes the demultiplexed wavelengths to generate a signal.

2. The apparatus for compensating for dispersion as claimed in claim 1,
wherein said wavelength-selective optical switching unit further includes a specific output node that is not connected to the dispersion compensation units, and outputs a specific demultiplexed wavelength from the specific output port.

3. The apparatus for compensating for dispersion as claimed in claim 1,
wherein said multiplexing unit receives a specific wavelength from a specific input port among the plurality of input ports and multiplexes said specific demultiplexed wavelength into a plurality of demultiplexed wavelengths output by said plurality of dispersion compensation units.

4. An apparatus for compensating for dispersion, comprising:
an optical circulating unit which includes a first port, a second port and a third port, and which receives at the first port a first signal into which a plurality of wavelengths is multiplexed so as to output from the second port the first signal, and receives a second signal at the second port so as to output from the third port the second signal;
a wavelength-selective optical switching unit which receives from said second port and at one input port a signal into which said plurality of wavelengths are multiplexed and demultiplexes the signal so as to output the demultiplexed wavelengths at desired output ports while switching routes of the demultiplexed wavelengths leading to the output ports; and
a plurality of dispersion compensation units which are connected to the respective output ports of said wavelength-selective optical switching unit, and have respective, different dispersion compensation values; and
a plurality of reflecting units which reflect and return output light at end section of said respective dispersion compensation units.

5. A wavelength division multiplexing communications system,
wherein the apparatus for compensating for dispersion as claimed in claim 1 is provided along an optical transmission line.

6. An apparatus for compensating for dispersion as claimed in claim 1,
wherein the respective dispersion compensation units are set to have the dispersion compensation values at regular intervals.

7. The apparatus for compensating for dispersion as claimed in claim 1,
wherein the multiplexing unit comprises a wavelength-selective optical switching unit which receives at the plurality of input ports thereof the demultiplexed wavelengths and multiplexes said demultiplexed wavelengths so as to output the signal at the output port while switching the routes of the demultiplexed wavelengths leading to the output port; and comprising
an optical loss adjusting unit which variably adjusts an optical loss of the respective demultiplexed wavelengths from the respective input ports to said one output port.

8. An apparatus for compensating for dispersion, comprising
a plurality of apparatuses for compensating for dispersion, each of which has an identical structure to the apparatus for compensating for dispersion as claimed in claim 6; and
a different dispersion compensation value, per apparatus for compensating for dispersion, which is set at regular intervals in the dispersion compensation units within each of the apparatus for compensating for dispersion.

9. An apparatus for compensating for dispersion as claimed in claim 1,
wherein said wavelength-selective optical switching unit includes
a first diffraction device which spectroscopes input light;
a plurality of mirrors which switch routes of wavelengths spectroscoped by said diffraction device; and
a second diffraction device which receives from said plurality of mirrors the spectroscoped wavelengths and multiplexes the spectroscoped wavelengths.

10. A wavelength division multiplexing communications system, comprising a plurality of apparatuses for compensating for dispersion at different locations along an optical transmission line, said plurality of apparatuses for compensating for dispersion being each identical to the apparatuses for compensating for dispersion of claim 8.
